(19) United States
(12) Patent Application Publication
(10) Pub. No.: US 2006/0232803 A1
(43) Pub. Date: Oct. 19, 2006

(54) Image processing method, profile creation method, and image processing apparatus

(75) Inventors: Ayumi Hori, Kawasaki-shi (JP); Yoshinori Kawai, Kawasaki-shi (JP); Manabu Yamazoe, Minato-ku (JP)

Correspondence Address: CANON U.S.A. INC. INTELLECTUAL PROPERTY DIVISION, 15975 ALTON PARKWAY, IRVINE, CA, 92618-3731, US

(73) Assignee: Canon Kabushiki Kaisha, Ohta-ku (JP)

(21) Appl. No.: 11/399,904

(22) Filed: Apr. 7, 2006

(30) Foreign Application Priority Data
Apr. 18, 2005 (JP) 2005-120018

(51) Int. Cl. H04N 1/60

(52) U.S. Cl. 358/1.9

(57) ABSTRACT

Three primary color points are defined to determine a working color space such that the working color space includes all colors in the color reproduction range of a printer. In addition, the luminance of a white point and a standard light source is defined. A transformation matrix is determined on the basis of these points. The transformation matrix associates an RGB working color space with a color space in the XYZ color system to define the RGB working color space. Thus, when compression gamut mapping is performed on the working color space, colors in the working color space can be mapped to any colors in the color reproduction range of a printer, without dropping any colors reproducible by the printer.

### BACKGROUND OF THE INVENTION

1. Field of the Invention

The present invention relates to image processing methods, profile creation methods, and image processing apparatuses, and particularly to techniques for defining a device-independent color space used in color conversion using profiles.

2. Description of the Related Art

With the proliferation of digital devices, such as digital cameras and image scanners, digital images have become readily available in recent years. At the same time, full-color hard-copying technologies have been developed rapidly. In particular, inkjet printing technologies offer print image quality nearly equivalent to that of silver halide film cameras. Moreover, the Internet and other network technologies provide an environment where a variety of input and output devices can be connected to networks. In such an environment where various input and output devices are available, there are cases in which color image signals displayed, for example, on a monitor with a wide color reproduction range are printed by a printer with a color reproduction range narrower than that of the monitor. In other words, color image data input to one device is output from another device with a different color reproduction range.

A “color management system” (hereinafter may be simply referred to as “CMS”) is widely known as a color matching process for consistent color reproduction across different devices.

FIG. 1 illustrates an exemplary configuration in which the CMS uses a device-independent color space. FIG. 1 shows a network to which input devices, such as cameras and scanners, and output devices, such as printers and monitors, are connected. In this configuration, a device-independent color space (for example, CIE-XYZ or CIE-L*a*b*) is involved in the process of conversion of input color signals to output color signals, where the profile of each of the input and output devices is used. Here, profile refers to a conversion equation for converting device-dependent colors into signals in a device-independent color space, or refers to a file in which such a conversion is described in the form of a lookup table (LUT).

The CMS uses a gamut mapping technique for compensating for the effects of variations in color reproduction range between input and output devices so that colors reproducible by the input device can be reproduced by the output device or that colors reproducible by the output device can be reproduced by the input device.

For example, Japanese Patent Laid-Open No. 6-225130 discusses a typical gamut mapping technique for input and output devices with different color reproduction ranges. In this technique, first, an input color space is converted to a uniform color space, which is a device-independent color space. Then, of all colors in this uniform color space, those irreproducible by the output device are compressed in a direction that allows the color difference to be minimized, or are nonlinearly compressed according to saturation while lightness is held constant. In another technique discussed in Japanese Patent Laid-Open No. 4-40072, first, an input color space is converted to a device-independent color space, such as a uniform color space or an HVC color space. Then, a determination is made as to whether the converted colors are outside the color reproduction range of the output device. If it is determined that a color is outside the color reproduction range of the output device, the value of the color is mapped to the value of the maximum saturation while the lightness and hue of the color are maintained.

In another technique discussed in Japanese Patent Laid-Open No. 2004-64464, an input color space is similarly converted to a device-independent color space, such as an sRGB color space (IEC61966-2-1) or AdobeRGB color space, as proposed by Adobe Systems Incorporated, having a color reproduction range wider than that of the sRGB color space. Then, after color processing, such as backlight compensation or correction for increasing color saturation, is performed in the device-independent color space, gamut mapping is performed for conversion to the color reproduction range dependent on the output device.

As described above, a device-independent color space is a color space which is subjected to gamut mapping and where color processing, such as increasing color saturation, is performed (hereinafter, such a color space will be referred to as “working color space”).

In gamut mapping, since the shape of a known working color space is changed basically only by mapping, such as compression, known gamut mapping can cause some problems described below.

First, the device-independent working color space discussed in the above-described documents cannot include the output device's full color reproduction range mapped through gamut mapping. This leads to a problem in that colors reproducible by the output device cannot be effectively used.

FIG. 2 illustrates this problem, and shows an sRGB working color space 201 and a color reproduction range 202 of an inkjet printer. In FIG. 2, the working color space 201 and the color reproduction range 202 are expressed in the color space of the CIE-L*a*b* (CIE1976) color system.

In the example illustrated in FIG. 2, a shaded portion of the color reproduction range 202 of the inkjet printer is outside the sRGB color space 201. In this case, the shaded portion of the color reproduction range 202 of the inkjet printer cannot be used when correction processing is performed in the working color space as described in Japanese Patent Laid-Open No. 2004-64464. In other words, a correction using colors within the range of the shaded portion cannot be made. When compression mapping is performed as described in Japanese Patent Laid-Open No. 6-225130, Japanese Patent Laid-Open No. 4-40072, and Japanese Patent Laid-Open No. 2004-64464, even if the working color space 201 is compressed, colors in this shaded portion do not exist in the mapping destination.

As described, if compression gamut mapping is applied to a working color space in the case where the working color space does not include the full color reproduction range of the output device, colors in the above-described shaded portion are not included in the compressed result. In other words, a part of the color reproduction range of the output device is not used in gamut mapping. The result is that full use of the entire color reproduction range of the output device cannot be made.

Another problem caused by gamut mapping is the reversal of color saturation and lightness. FIG. 3 illustrates this problem and shows the relationship between a working color space 301 and a color reproduction range 302 of an inkjet printer expressed in the CIE-L*a*b* color system.

Referring to FIG. 3, a point 305 represents the maximum saturation of a particular primary color in the working color space 301, and a point 303 represents a compression direction point to which gamut mapping is directed. A point 304 represents the maximum saturation of a color (primary color) included in the color reproduction range 302 of the inkjet printer and having the same hue as that of the primary color represented by the point 305. FIG. 3 is a two-dimensional representation of the CIE-L*a*b* color system, and the b*-axis, which actually exists, is omitted for simplicity.

When gamut mapping toward the compression direction point 303 is applied to the point 305 in the working color space 301 while the hue of the point 305 is maintained, the point 305 is mapped to the position of a point 306 in the printer's color reproduction range 302. Compared with the point 306, the maximum saturation point 304 in the printer's color reproduction range 302 is located at the position representing a higher saturation level (a* and b*) and a lower lightness level (L*). In this case, it is preferable for a color defined in the working color space 301, such as a color of an image with color gradations ranging from white (A) via the maximum saturation point 305 to black (B), to pass through the point 306 and maximum saturation point 304 in the printer's color reproduction range 302, and to be mapped to a color (point) at an outermost position in the printer's color reproduction range 302. However, the maximum saturation point 305 is mapped to the point 306 instead of being mapped to the maximum saturation point 304 in the printer's color reproduction range 302, while a point 307 representing a color with a lower saturation than that represented by the maximum saturation point 305 is mapped to the maximum saturation point 304 in the printer's color reproduction range 302. Gamut mapping thus causes the reversal of saturation. Similarly, there may be cases where the reversal of lightness and hue occur.

On the other hand, it may be possible to define a compression direction point such that the maximum saturation point 305 in the working color space 301 passes through the maximum saturation point 304 in the printer's color reproduction range 302. However, this method involves complex and cumbersome processing for identifying the maximum saturation point in the printer's color reproduction range 302, and thus cannot be simply adopted.

As described above, in conventional gamut mapping, the shape of the working color space is determined without taking the shape of the color reproduction range of the output device into account. Therefore, there are some cases where a color match between a specific color in the working color space and a specific color in the color reproduction range of the output device cannot be ensured by gamut mapping, and thus accurate color reproduction cannot be achieved.

Another conventional problem is associated with the conversion of nonexistent color information. For example, color space conversion (gamut mapping) is often performed using a three-dimensional LUT. In this case, if a color space expressed in the CIE-L*a*b* color system or CIE-XYZ color system is used as a working color space, colors that do not exist in the color space are also described in the LUT. This results in the conversion of colors including unnecessary colors, and can cause a relative decrease in the accuracy of the LUT. In other words, if unnecessary color information is described in the LUT, the ratio of space available for describing necessary color information decreases. Therefore, the conversion of necessary colors has to be carried out with a smaller number of grid points than in the case where no nonlinear element is included, and conversion accuracy is degraded.

### SUMMARY OF THE INVENTION

The present invention has been made to solve the problems described above, and provides an image processing method, a program, and an image processing apparatus that can prevent inconvenience associated with color reproduction and caused by problems related to the shape of a working color space involved in gamut mapping, thus allowing good color reproduction to be achieved.

According to an aspect of the present invention, an image processing method includes performing gamut mapping on image data in a first color reproduction range to convert the image data into image data in a second color reproduction range, wherein the first color reproduction range is defined in a predetermined chromaticity diagram by a combination including three primary color points to include the second color reproduction range.

According to another aspect of the present invention, an image processing method includes performing gamut mapping on image data in a first color reproduction range to convert the image data into image data in a second color reproduction range, wherein the shape of the first color reproduction range is determined based on the shape of the second color reproduction range.

According to yet another aspect of the present invention, an image processing method includes converting input color data into converted color data in a first color reproduction range and performing gamut mapping on the converted image data in the first color reproduction range to convert the converted image data into image data in a color reproduction range of a printer, wherein the shape of the first color reproduction range is determined based on the shape of the second color reproduction range.

Further features of the present invention will become apparent from the following description of exemplary embodiments with reference to the attached drawings.

### BRIEF DESCRIPTION OF THE DRAWINGS

FIG. 1 illustrates an exemplary overall configuration of a CMS using color profiles.

FIG. 2 illustrates a problem that can arise when a device-independent working color space does not include the output device's full color reproduction range mapped through gamut mapping.

FIG. 3 illustrates a problem of the reversal of saturation and lightness that can be caused by gamut mapping.

FIG. 4 is a block diagram showing an overall configuration of a host computer according to an exemplary embodiment of an image processing apparatus of the present invention.

FIG. 5 is a block diagram showing exemplary image processing performed by a printer driver shown in FIG. 4.

FIG. 6 is a block diagram showing details of processing performed by a color space conversion/processing unit shown in FIG. 5.

FIG. 7 is a flowchart showing an exemplary basic process of a defining method.

FIG. 8 illustrates an exemplary (x,y)-type chromaticity coordinate system in which the coordinates of each of three primary colors, red, green, and blue are defined in the XYZ color system.

FIG. 9 is a flowchart showing an exemplary process of defining a working color space according to a first embodiment of the present invention.

FIG. 10 is an exemplary (x,y)-type chromaticity diagram showing a color reproduction range of a printer and a spectrum locus marking the boundary of a visible region, according to the first embodiment.

FIG. 11 illustrates an exemplary method for defining a working color space according to the first embodiment.

FIG. 12 illustrates the points of three primary colors defined by the exemplary method for defining a working color space according to the first embodiment.

FIG. 13 is a flowchart showing an exemplary process of defining a working color space according to a second embodiment of the present invention.

FIG. 14 illustrates an exemplary process for moving the position of each primary color and the like in a working color space according to the second embodiment.

FIG. 15 illustrates an exemplary relationship between the working color space and a printer's color reproduction range after the process illustrated in FIG. 14.

FIG. 16 illustrates another exemplary process for moving the position of each primary color and the like in a reference working color space according to the second embodiment.

FIG. 17 illustrates an exemplary relationship between the working color space and a printer's color reproduction range after the process illustrated in FIG. 16.

FIG. 18 illustrates an exemplary compression method performed with lightness held constant, according to a modification of the second embodiment.

FIG. 19 illustrates an exemplary relationship between a working color space and a printer's color reproduction range after the process illustrated in FIG. 18.

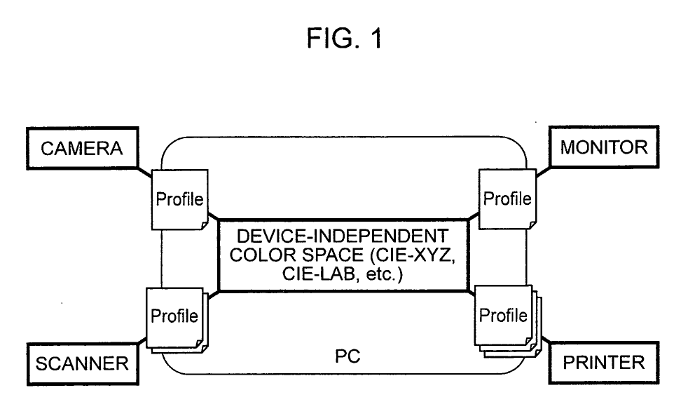

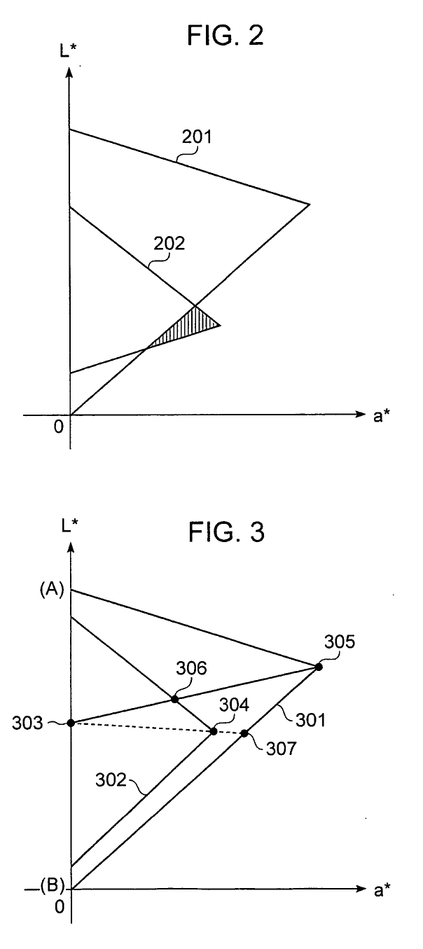

### DESCRIPTION OF THE EMBODIMENTS

Embodiments of the present invention will now be described with reference to the drawings.

FIG. 4 is a block diagram showing an overall configuration of a host computer according to an exemplary embodiment of an image processing apparatus of the present invention. Referring to FIG. 4, a host computer 400 includes software programs, such as application software 401 including a word processor, a spreadsheet program, and an Internet browser; an operating system (OS) 402; a printer driver 403 processing a group of various drawing commands (such as image drawing commands, text drawing commands, and graphic drawing commands) issued from the application software 401 to the OS 402 to generate print data representing images to be output by a printer 404; and a monitor driver 405 generating image data to be displayed on a monitor 406. The host computer 400 further includes various types of hardware that operate the software programs described above. Examples of such hardware include a hard disk drive (HDD) 407, a central processing unit (CPU) 408, a random-access memory (RAM) 409, and a read-only memory (ROM) 410.

Specifically, examples of the host computer 400 include a personal computer having Windows (registered trademark of Microsoft Corporation) serving as the OS 402, and in which application software with a print setting function is installed as the application software 401. Moreover, examples of the printer 404 include an inkjet printer and an electrophotographic printer, while examples of the monitor 406 include a cathode-ray tube (CRT) and a liquid crystal display (LCD).

With the configuration described above, the application software 401 generates image data representing an image displayed on the monitor 406. Specifically, the image data generated by the application software 401 contains text data representing text including characters, graphics data representing graphics such as drawings, and image data representing images such as photographic images. For printing the image displayed on the monitor 406, a print request is issued from the application software 401 to the OS 402. A group of drawing commands, including text drawing commands corresponding to the text data, graphics drawing commands corresponding to the graphics data, and image drawing commands corresponding to the image data, is sent to the OS 402. Upon receipt of the print request, the OS 402 sends the group of drawing commands to the printer driver 403 corresponding to a printer to be used for printing.

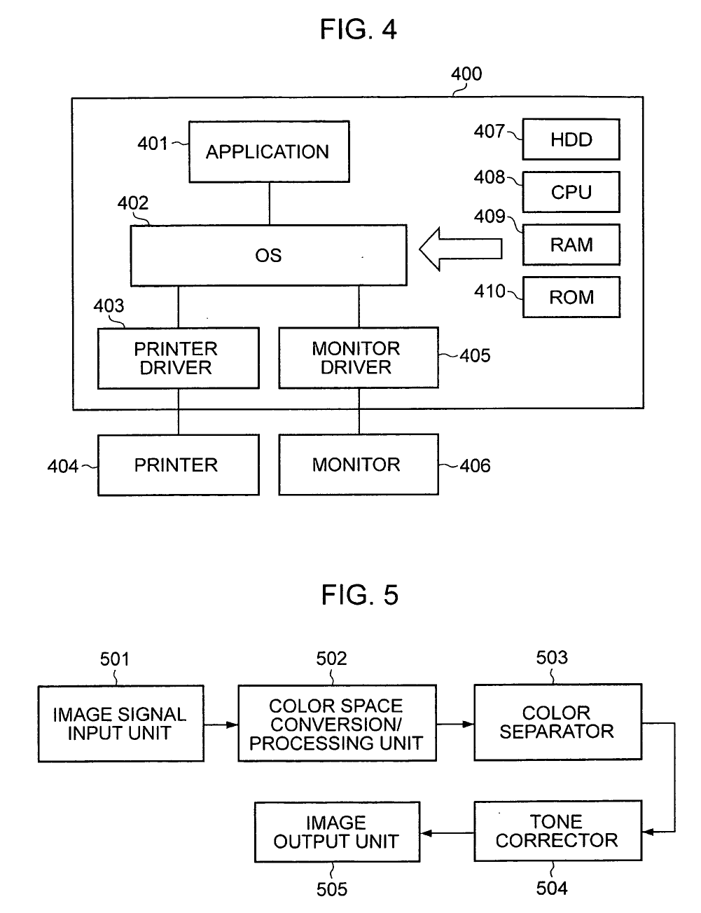

The printer driver 403 processes the print request and group of drawing commands input from the OS 402 to generate print data printable by the printer 404, and transfers the print data to the printer 404. If the printer 404 is a raster printer, when the group of drawing commands is received, the printer driver 403 sequentially rasterizes and stores the image in an RGB 24-bit page memory. Upon completion of the rasterization of the entire image in response to the group of drawing commands, the printer driver 403 performs image processing (described below with reference to FIG. 5) on RGB data stored in the page memory, converts the RGB data to data printable by the printer 404, and transfers the data to the printer 404. For example, the printer driver 403 converts the RGB data to CMYK data and transfers the CMYK data to the printer 404.

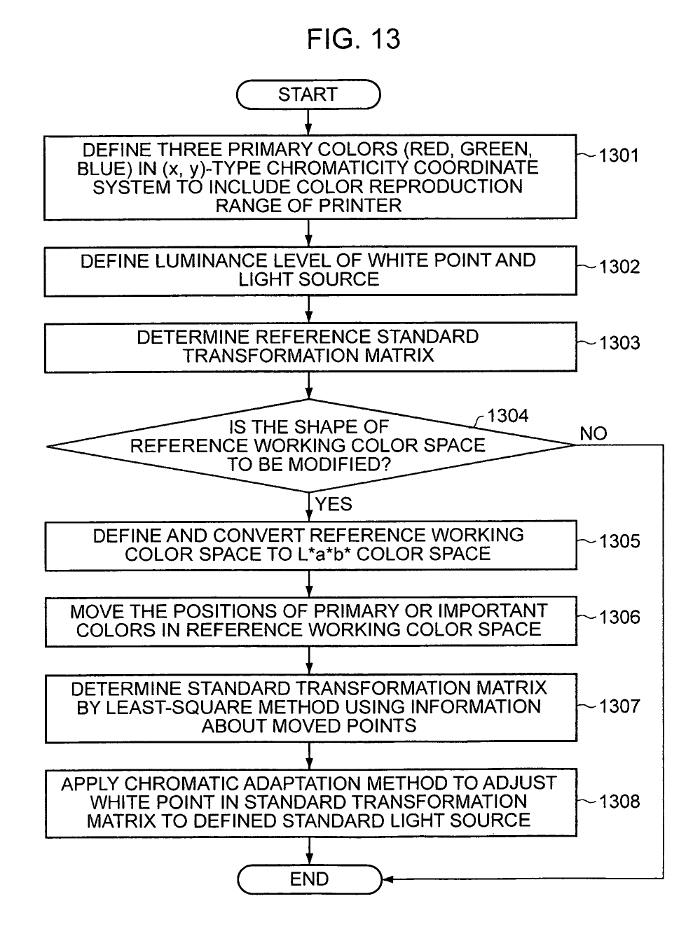

The definition and creation of a working color space, and the creation of conversion configuration or an LUT for achieving a gamut mapping method using a working color space (described below with reference to FIG. 9 and FIG. 13) are performed by a computer such as the host computer 400 shown in FIG. 4. Alternatively, the LUT may be one prepared in advance as a profile.

FIG. 5 is a block diagram showing exemplary image processing performed by the printer driver 403.

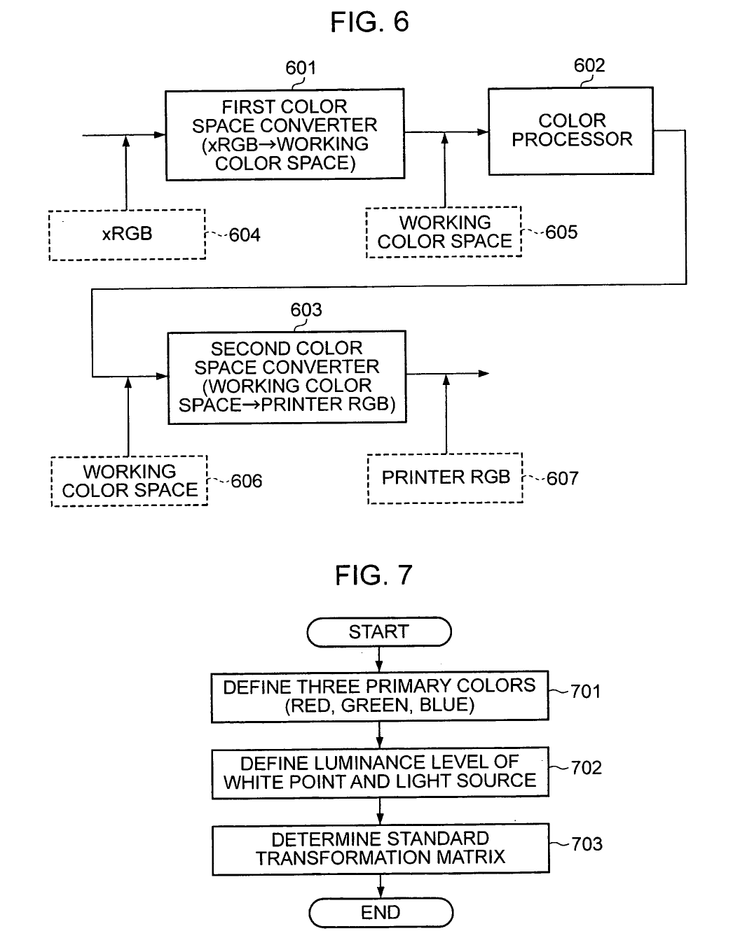

Referring to FIG. 5, RGB image data input to an image signal input unit 501 is sent to a color space conversion/processing unit 502. Upon receipt, the color space conversion/processing unit 502 performs gamut mapping (color space conversion) and color processing on the input image data, as described below in detail with reference to FIG. 6. Specifically, in the gamut mapping process, the color space conversion/processing unit 502 maps the image data in an input device's color space, which defines input data, into the color reproduction range of the printer 404, which is an output device. Upon completion of the color space conversion and color processing on the RGB image data, a color separator 503 performs color separation on the RGB image data, thus separating the RGB image data into CMYK image data, which is a signal of ink to be used in the printer 404. A tone corrector 504 performs tone correction and quantization on the CMYK image data to generate dot data. Then, an image output unit 505 outputs CMYK dot data corresponding to each ink color to the printer 404, at predetermined timing.

The color separation in the color separator 503 is performed by taking various conditions into account. Examples of such conditions include the granularity of ink dots formed by the inkjet printer 404, the total number of ink droplets that can be received per unit time and unit area by a recording medium, and the continuity of colors and tones. In other words, a color separation table is predefined such that color separation is performed in consideration of these conditions and that an appropriate combination of CMYK colors can be output. If color processing in the printer is performed using the color separation table, the printer can be treated as an RGB device that simply processes RGB data. In this case, a color space made up of the RGB data is called a printer RGB color space.

FIG. 6 is a block diagram showing details of processing performed by the color space conversion/processing unit 502 shown in FIG. 5.

Referring to FIG. 6, RGB input image data is input from the image signal input unit 501. Examples of a color space 604 defining the input image data include an sRGB color space and an AdobeRGB color space, which will hereinafter be collectively referred to as xRGB color space. A first color space converter 601 converts the image data in the xRGB color space 604 to image data defined by RGB values in a working color space 605. Next, a color processor 602 performs color correction, such as increasing color saturation, or color processing on the image data in the working color space 605. Then, a second color space converter 603 converts the processed image data in an RGB working color space 606 to image data in a printer RGB color space 607 that is the color reproduction range of the printer 404. Specifically, to achieve the conversion described above, the first color space converter 601 and the color processor 602 each perform interpolation calculations as well as using an LUT.

In the configuration described above, as described below in detail with reference to FIG. 9 and subsequent figures, both the working color space 605 and the working color space 606 are defined so as to include all colors within the color reproduction range of the printer 404. Also, the shape and range of both the working color space 605 and the working color space 606 are defined such that a specific color in the working color space is converted by gamut mapping to the corresponding color in the color reproduction range of the printer 404.

A basic method for defining a working color space according to an exemplary embodiment of the present invention will now be described. This defining method is used to define a working color space in each embodiment of the present invention described with reference to FIG. 9 and subsequent figures.

FIG. 7 is a flowchart showing an exemplary basic process of the defining method described above. When a working color space is to be defined as an RGB color space as in the present embodiment, the RGB color space is defined in correspondence to a device-independent color space so that the RGB color space is treated as a device-independent color space. Therefore, in the present embodiment, a standard transformation matrix Kₛ that linearly converts the RGB color space to a device-independent tristimulus value space (CIE-XYZ color system) is determined to define the RGB color space as a device-independent working color space. By defining the RGB color space in correspondence to the color space in the XYZ color system, the working color space can be defined in the device-independent color space.

Thus, in the first color space converter 601 shown in FIG. 6, the xRGB color space 604 is mapped to the RGB working color space 605 defined in correspondence to the XYZ color system using the standard transformation matrix Kₛ, as will be described below.

Mapping from an RGB color space to an XYZ color space can be expressed by Equation (1.1):

$$( \begin{matrix}X \\ Y \\ Z\end{matrix} ) = ( \begin{matrix}{k}_{S 1 \; 1} & {k}_{S 12} & {k}_{S 13} \\ {k}_{S 21} & {k}_{S 22} & {k}_{S 23} \\ {k}_{S 31} & {k}_{S 32} & {k}_{S 33}\end{matrix} ) ( \begin{matrix}R \\ G \\ B\end{matrix} ) \qquad ( 1.1 )$$

where the standard transformation matrix Kₛ that converts the RGB color space to the color space in the CIE-XYZ color system is expressed as Kₛ={k_{Sij}}, and “i” and “j” are natural numbers ranging from 1 to 3.

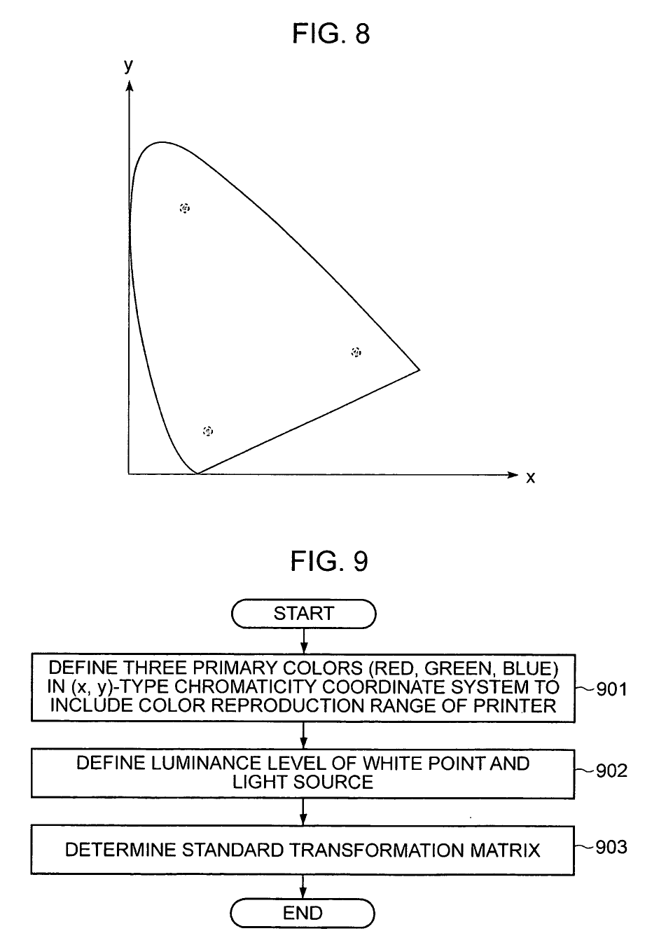

Nine independent conditions are required to determine nine elements of the three by three standard transformation matrix Kₛ. In step S701 in FIG. 7, the three primary colors red (1,0,0), green (0,1,0), and blue (0,0,1) are defined as (R,G,B) values in an (x,y)-type chromaticity coordinate system. The coordinates of the three primary colors, which are expressed as red (x_{R},y_{R},z_{R}), green (x_{G},y_{G},z_{G}), and blue (x_{B},y_{B},z_{B}) in the (x,y)-type chromaticity coordinate system, are converted to coordinates in the (X,Y,Z) coordinate system using Equations (1.2) to (1.9) described below, and substituted into Equation (1.1). Referring to FIG. 8, the coordinates of the three primary colors, red (x_{R}, y_{R}, z_{R}), green (x_{G}, y_{G}, z_{G}), and blue (x_{B}, y_{B}, z_{B}), are defined in the (x,y)-type chromaticity coordinate system in the XYZ color system. This definition gives six conditions (Equation (1.13); z is dependent on x and y).

In step S702 in FIG. 7, a white color is defined by the conditions of a standard light source. For example, the tristimulus values of a light source, Xn, Yn, and Zn, can be expressed by Equations (1.2), (1.3), and (1.4):

$$\begin{matrix}Xn = \frac{\int S ( λ ) \overline{x} ( λ ) ⅆ λ}{\int S ( λ ) \overline{y} ( λ ) ⅆ λ} & ( 1.2 ) \\ Yn = \frac{\int S ( λ ) \overline{y} ( λ ) ⅆ λ}{\int S ( λ ) \overline{y} ( λ ) ⅆ λ} = 1.0 & ( 1.3 ) \\ Zn = \frac{\int S ( λ ) \overline{z} ( λ ) ⅆ λ}{\int S ( λ ) \overline{y} ( λ ) ⅆ λ} & ( 1.4 )\end{matrix}$$

where \overline{x}(λ), \overline{y}(λ), and \overline{z}(λ) and are color-matching functions at a view angle of 2° in the CIE-XYZ color system, and S(λ) is the spectral reflectance properties of the standard light source.

The CIE-XYZ color system can be converted to the (x,y)-type chromaticity coordinate system by Equations (1.5), (1.6), and (1.7):

$$\begin{matrix}x = \frac{X}{X + Y + Z} & ( 1.5 ) \\ y = \frac{Y}{X + Y + Z} & ( 1.6 ) \\ z = \frac{Z}{X + Y + Z} & ( 1.7 )\end{matrix}$$

In general, the relationships expressed by the following Equations (1.8) and (1.9) are valid:

$$\begin{matrix}X = \frac{x}{y} Y & ( 1.8 ) \\ Z = \frac{z}{y} Y & ( 1.9 )\end{matrix}$$

The above-described equations are used to convert the tristimulus values of the standard light source to values in the (x,y)-type chromaticity coordinate system by Equations (1.10), (1.11), and (1.12):

$$\begin{matrix}{x}_{n} = \frac{Xn}{Xn + Yn + Zn} & ( 1.10 ) \\ {y}_{n} = \frac{Yn}{Xn + Yn + Zn} & ( 1.11 ) \\ {z}_{n} = \frac{Zn}{Xn + Yn + Zn} & ( 1.12 )\end{matrix}$$

The resulting color is the same as the color observed when the light source illuminates a perfectly diffuse reflector (i.e., the color of the light source).

Eight conditions are thus obtained, as z is dependent on x and y. Then, for example, the luminance level of white (Yn) is determined to add one more condition. This brings the total to nine conditions, which are used to determine the nine elements of the transformation matrix.

Substituting the coordinates of red, green, and blue and the corresponding tristimulus values (expressed as x_{R}, x_{G}, and x_{B}) into Equation (1.1) gives the following Equation (1.13):

$$( \begin{matrix}{k}_{S 1 \; 1} & {k}_{S 12} & {k}_{S 13} \\ {k}_{S 21} & {k}_{S 22} & {k}_{S 23} \\ {k}_{S 31} & {k}_{S 32} & {k}_{S 33}\end{matrix} ) ( \begin{matrix}1 & 0 & 0 \\ 0 & 1 & 0 \\ 0 & 0 & 1\end{matrix} ) = ( \begin{matrix}{X}_{R} & {X}_{G} & {X}_{B} \\ {Y}_{R} & {Y}_{G} & {Y}_{B} \\ {Z}_{R} & {Z}_{G} & {Z}_{B}\end{matrix} ) \qquad ( 1.13 )$$

Moreover, substituting the tristimulus values of white based on Equations (1.10), (1.11), and (1.12) into Equation (1.13) gives the following Equation (1.14):

$$( \begin{matrix}{k}_{S 1 \; 1} & {k}_{S 12} & {k}_{S 13} \\ {k}_{S 21} & {k}_{S 22} & {k}_{S 23} \\ {k}_{S 31} & {k}_{S 32} & {k}_{S 33}\end{matrix} ) ( \begin{matrix}1 \\ 1 \\ 1\end{matrix} ) = ( \begin{matrix}{X}_{n} \\ {Y}_{n} \\ {Z}_{n}\end{matrix} ) \qquad ( 1.14 )$$

If X and Z are represented by Y using the relationship given by Equation (1.9), Equation (1.13) can be rewritten as Equation (1.15):

$$( \begin{matrix}{k}_{S 1 \; 1} & {k}_{S 12} & {k}_{S 13} \\ {k}_{S 21} & {k}_{S 22} & {k}_{S 23} \\ {k}_{S 31} & {k}_{S 32} & {k}_{S 33}\end{matrix} ) = ( \begin{matrix}\frac{{x}_{R}}{{y}_{R}} & \frac{{x}_{G}}{{y}_{G}} & \frac{{x}_{B}}{{y}_{B}} \\ 1.0 & 1.0 & 1.0 \\ \frac{{z}_{R}}{{y}_{R}} & \frac{{z}_{G}}{{y}_{G}} & \frac{{z}_{B}}{{y}_{B}}\end{matrix} ) ( \begin{matrix}{Y}_{R} & 0 & 0 \\ 0 & {Y}_{G} & 0 \\ 0 & 0 & {Y}_{B}\end{matrix} ) \qquad ( 1.15 )$$

and Equation (1.14) can be rewritten as Equation (1.16):

$$( \begin{matrix}{k}_{S 1 \; 1} & {k}_{S 12} & {k}_{S 13} \\ {k}_{S 21} & {k}_{S 22} & {k}_{S 23} \\ {k}_{S 31} & {k}_{S 32} & {k}_{S 33}\end{matrix} ) ( \begin{matrix}1 \\ 1 \\ 1\end{matrix} ) = ( \begin{matrix}\frac{{x}_{n}}{{y}_{n}} {Y}_{n} \\ {Y}_{n} \\ \frac{{z}_{n}}{{y}_{n}} {Y}_{n}\end{matrix} ) \qquad ( 1.16 )$$

Combining Equations (1.15) and (1.16) to eliminate the standard transformation matrix gives the following Equation (1.17):

$$( \begin{matrix}\frac{{x}_{R}}{{y}_{R}} & \frac{{x}_{G}}{{y}_{G}} & \frac{{x}_{B}}{{y}_{B}} \\ 1.0 & 1.0 & 1.0 \\ \frac{{z}_{R}}{{y}_{R}} & \frac{{z}_{G}}{{y}_{G}} & \frac{{z}_{B}}{{y}_{B}}\end{matrix} ) ( \begin{matrix}{Y}_{R} \\ {Y}_{G} \\ {Y}_{B}\end{matrix} ) = ( \begin{matrix}\frac{{x}_{n}}{{y}_{n}} {Y}_{n} \\ {Y}_{n} \\ \frac{{z}_{n}}{{y}_{n}} {Y}_{n}\end{matrix} ) \qquad ( 1.17 )$$

Substituting Y_{R}, Y_{G}, and Y_{B} determined by Equation (1.17) into Equation (1.15) gives the luminance level of white (Yn). The standard transformation matrix can thus be uniquely determined in step S703.

As described above, the device-independent color space in the XYZ color system is involved in the process of defining the RGB working color space. In other words, the RGB working color space is defined by determining the standard transformation matrix that describes the relationship for associating the color space in the XYZ color system with the RGB working color space.

Embodiments of a working color space defined by the above-described basic defining method will now be described. Using a working color space defined by the above-described method can prevent inconvenience associated with color reproduction and caused by gamut mapping.

### First Embodiment

FIG. 9 is a flowchart showing an exemplary process of defining a working color space according to the first embodiment of the present invention.

Referring to FIG. 9, in step S901, the coordinates of the three primary colors, red, green, and blue, are defined in an (x,y)-type chromaticity diagram for the XYZ color system such that the color reproduction range of the printer 404, which is an output device, is included.

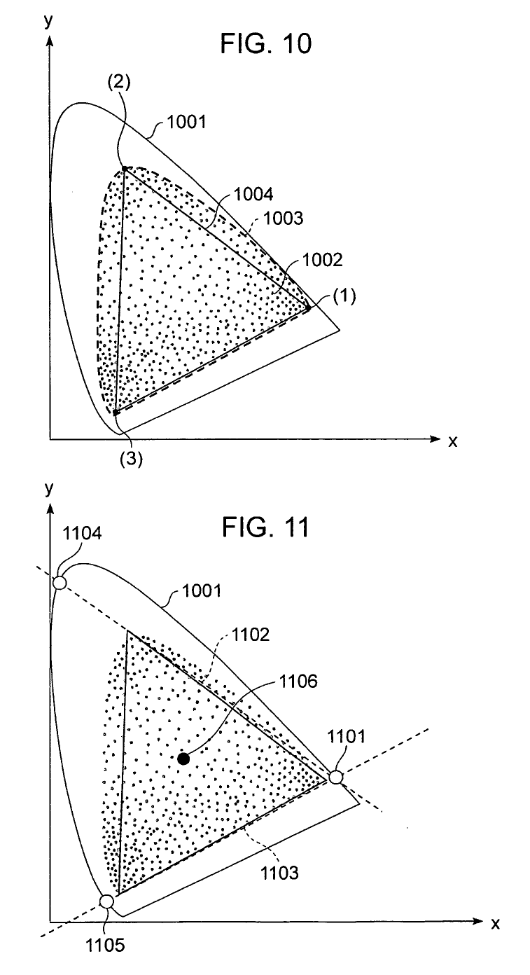

FIG. 10 is an exemplary (x,y)-type chromaticity diagram showing a color reproduction range 1002 of the printer 404 and a spectrum locus 1001 marking the boundary of a visible region. The area inside the horseshoe spectrum locus 1001 represents the visible region. In FIG. 10, a smooth dashed line 1003 marks the outer boundary of the color reproduction range 1002 of the printer 404 with a regression curve, such as a spline curve. Three points lying on the dashed line 1003 and satisfying the following conditions (1) to (3) are identified and connected by straight lines to form a triangle 1004. The conditions are as follows:

(1) a point with the maximum x value

(2) a point with the maximum y value

(3) a point with the minimum x and y values

As shown in FIG. 10, the color reproduction range 1002 of the printer 404 is characterized in that the red region is particularly close to the spectrum locus 1001. Therefore, in the present embodiment, the points of the three primary colors are defined with respect to the red region.

As shown in FIG. 11, of the three points on the triangle 1004 described above, a point that satisfies condition (1) is moved parallel to the x-axis and made to intersect with the spectrum locus 1001. A point 1101 at the intersection with the spectrum locus 1001 is defined as a red (primary color) point.

Next, a straight line 1102 is drawn from the point 1101 to a point that satisfies condition (2), while a straight line 1103 is drawn from the point 1101 to a point that satisfies condition (3). An intersection point 1104 of the straight line 1102 and the spectrum locus 1001 is defined as a green point, while an intersection point 1105 of the straight line 1103 and the spectrum locus 1001 is defined as a blue point.

At this point in time, however, a triangle formed by the red point 1101, the green point 1104, and the blue point 1105 is inside the outer boundary (dashed line 1003) of the color reproduction range 1002 of the printer 404. Therefore, the triangle is moved from the current position of the green point 1104 along the spectrum locus 1001 to find a position where the triangle is outside the outer boundary (dashed line 1003) of the color reproduction range 1002, but inside the spectrum locus 1001. The same operation is performed with respect to the blue point 1105. A known geometric method is used to determine whether the triangle is outside the outer boundary of the color reproduction range 1002 of the printer 404, but within the area inside the spectrum locus 1001.

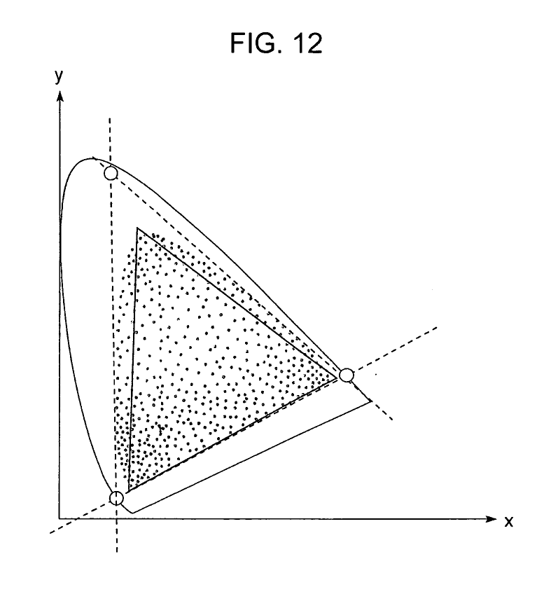

Moreover, the point 1104 is moved toward a white point 1106 in the visible region such that the area of a triangle formed by straight lines connecting the red point 1101 and the moved points 1104 and 1105 is smallest. Red, green, and blue points defined as the result of the same processing applied to the point 1105 and the point 1101, which serves as a reference point, are determined to be the optimal solutions of the three primary color points. The three optimal points are illustrated in FIG. 12. These points represent the three primary colors defined in step S701 in FIG. 7.

A method for defining the three primary colors is not limited to that described above and other methods may also be used, as long as the outer boundary of the color reproduction range 1002 of the printer 404 is included.

Next, in step S902, after a standard light source of the working color space is determined, a white point and the luminance thereof are defined. Since the output device of the present embodiment is an inkjet printer, a white point of D50, which is a standard observation light source for printed matter, is selected. The luminance of the white point is set to one. This white point and the luminance level of the white point correspond to those defined in step S702 in FIG. 7.

In step S903, a reference standard transformation matrix is determined on the basis of the conditions given in step S901 and step S902. Substituting a reference transformation matrix M0 into Equation (1.1) to calculate back the resulting standard transformation matrix gives an RGB reference working color space WO (corresponding to the working color space 605 in FIG. 6) associated with the CIE-XYZ color system.

The first color space converter 601 shown in FIG. 6 converts input xRGB image data to RGB image data in the working color space WO obtained in the way described above. The following calculation is required for conversion from the input xRGB color space to the working color space W0. First, if a gamma value is defined in the input xRGB color space, the input xRGB image data is multiplied by the inverse gamma to obtain a linear RGB value. Then, if a matrix for converting the input xRGB color space to the XYZ color system is expressed as Kx={kxij}, the input xRGB color space can be converted to the XYZ color space by the following equation:

$$( \begin{matrix}kx 11 & kx 12 & kx 13 \\ kx 21 & kx 22 & kx 23 \\ kx 31 & kx 32 & kx 33\end{matrix} ) ( \begin{matrix}Rx \\ Gx \\ Bx\end{matrix} ) = ( \begin{matrix}X \\ Y \\ Z\end{matrix} )$$

where the subscript “x” of each of R, G, and B represents the xRGB color space. Furthermore, the XYZ color system is converted to the reference working color space WO (expressed as Mw0={mw0ij} in matrix form) by the following equation:

$$( \begin{matrix}mw 0 \; 11 & mw 012 & mx 013 \\ mw 021 & mw 022 & mw 023 \\ mw 031 & mw 032 & mw 033\end{matrix} ) ( \begin{matrix}X \\ Y \\ Z\end{matrix} ) = ( \begin{matrix}Rw 0 \\ Gw 0 \\ Bw 0\end{matrix} )$$

Then, the color processor 602 applies backlight compensation or correction for increasing the color saturation to the converted image data. The resulting working color space 606 is thus subjected to gamut mapping by the second color space converter 603.

Since color processing performed by the color processor 602 is processing performed only in the working color space, the shape of the working color space 605 given by the processing illustrated in FIG. 9, that is, the shape defined as described above to include the full color reproduction range of the printer is not changed. Therefore, gamut mapping applied to the working color space 606 after the color processing does not cause any problems in color reproduction. That is, problems such as the occurrence of unused colors in the color reproduction range of the printer, and the mapping of colors outside the working color space, can be prevented.

It is not always necessary that the color processor 602 performs color processing on the working color space. In other words, all that is necessary is that the shape of the working color space subjected to gamut mapping is defined so as to include the full color reproduction range of the printer. Therefore, the working color space 605 may be subjected to gamut mapping by the second color space converter 603 without being processed by the color processor 602.

As described above, according to the present embodiment, the working color space can be expanded to include all colors in the color reproduction range of the printer. Therefore, when compression gamut mapping is performed on the working color space, colors in the working color space can be mapped to any colors in the color reproduction range of the printer, without dropping any colors reproducible by the printer. The full color reproduction range of the printer can thus be effectively used. Moreover, since the RGB color space is used as the working color space, the LUT for mapping can describe colors that actually exist. A decrease in LUT accuracy, which may occur when colors that do not exist are described, can thus be prevented.

### Second Embodiment

In the second embodiment, the working color space is defined so as to prevent gamut mapping from causing the reversal of color saturation and lightness, as well as to include the full color reproduction range of the printer as described in the first embodiment. Specifically, the position of each primary color in the working color space is moved so as to adjust the shape of the working color space to the shape of the color reproduction range of the printer, thus determining the shape of the working color space.

FIG. 13 is a flowchart showing an exemplary process of defining a working color space according to the present embodiment.

Steps S1301 to S1303 in FIG. 13 will not be described here, as they are substantially the same as those described in the first embodiment (Steps S902 to S903 shown in FIG. 9).

In step S1304, a determination is made as to whether the shape of the reference working color space WO determined in step S1303 is to be changed or adjusted. If it is determined that the shape is not to be changed, the process ends. That is, if no processing other than expanding the working color space as in steps S1301 to S1303 is required, the process ends.

On the other hand, if it is determined that the shape of the working color space is to be changed, the reference working color space W0 determined in step S1303 is converted to a working color space W0_{Lab} in the CIE-L*a*b* color system (step S1305). This conversion is performed on the basis of the conversion relationship defined between the working color space W0 and the L*a*b* color system via the XYZ color system.

Next, in step S1306, points representing primary colors (such as red (R), green (G), blue (B), cyan (C), magenta (M), and yellow (Y)) in the reference working color space W0_{Lab} in the L*a*b* color system are moved to respective positions suitable for gamut mapping. In other words, the primary color points in the working color space W0_{Lab} are moved in advance such that they are mapped to their corresponding primary color points in the color reproduction range of the printer.

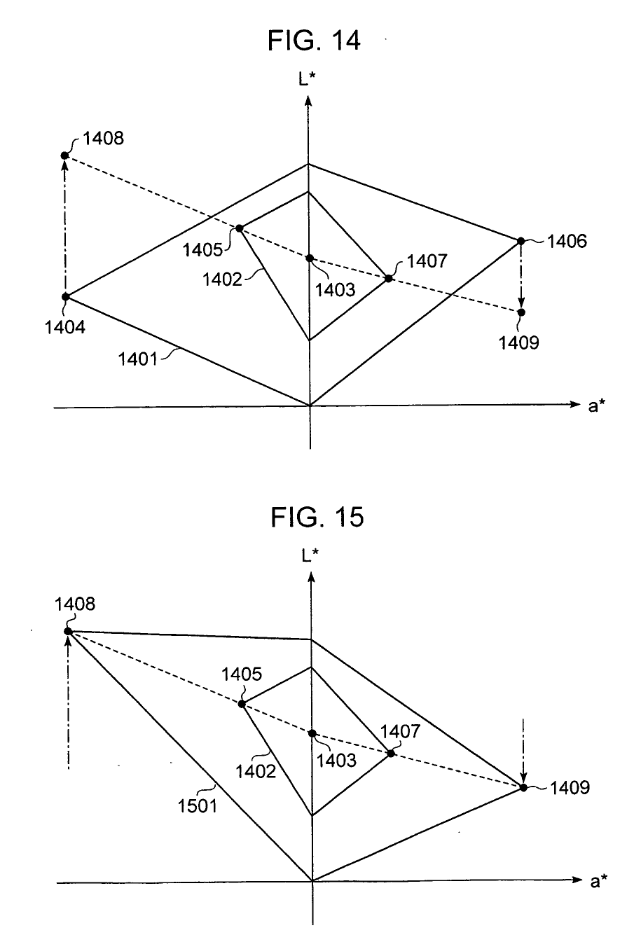

FIG. 14 illustrates a reference working color space (W0_{Lab}) 1401 and a color reproduction range 1402 of the printer 404 in the CIE-L*a*b* color system.

Referring to FIG. 14, a point 1403 represents a convergence point for compression in gamut mapping. In other words, in the present embodiment, compression gamut mapping toward the point 1403, while hue is held constant, is performed. A point 1405 and a point 1407 represent two of the above-described primary colors in the color reproduction range 1402 of the printer 404. A point 1404 and a point 1406 in the working color space 1401 represent the same primary colors as those represented by the point 1405 and the point 1407, respectively.

On the basis of this relationship between the working color space 1401 and the color reproduction range 1402, the point 1404 is moved to the position of a point 1408 and the point 1406 is moved to the position of a point 1409. Specifically, the point 1404 is moved such that a point representing a primary color in a working color space is located on the extension of a straight line between the convergence point 1403 and the point 1405, while the point 1406 is moved such that a point representing another primary color point in the working color space is located on the extension of a straight line between the convergence point 1403 and the point 1407. FIG. 15 illustrates the relationship between the color reproduction range 1402 of the printer 404 and a working color space 1501 given as a result of the above-described movement. Points representing the above-described primary colors are all moved in the same manner as that described above to change the shape of the working color space.

When compression gamut mapping toward the single convergence point is performed on the working color space through changing the shape of the working color space, the primary color points are mapped to their corresponding primary color points in the color reproduction range of the printer. Therefore, the reversal of saturation and lightness can be prevented.

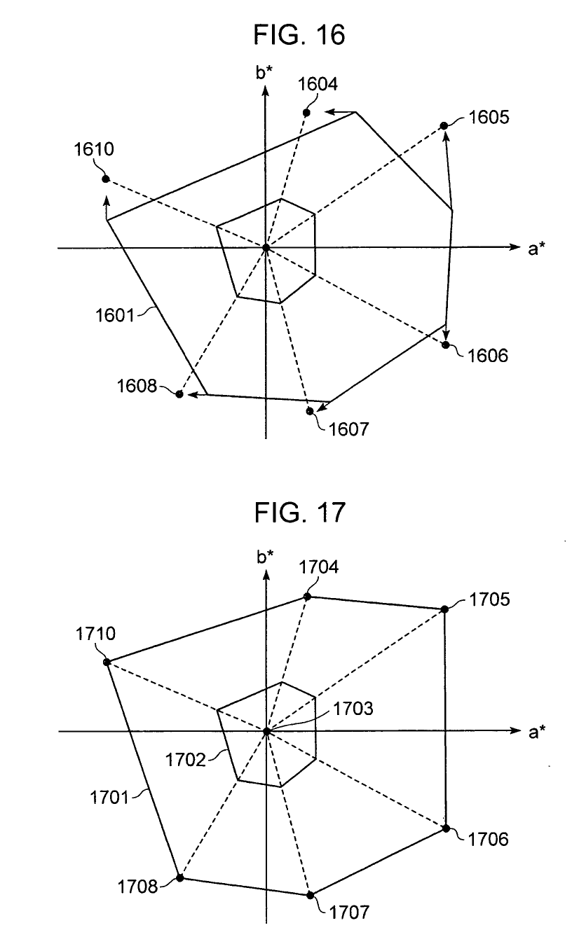

FIG. 16 illustrates an a*b* plane on which a working color space before the change of its shape and a printer's color reproduction range in the CIE-L*a*b* color system are projected. The primary color points in a working color space 1601 are moved to respective points 1604, 1605, 1606, 1607, 1608, and 1610. FIG. 17 illustrates the relationship between a working color space 1701 formed by changing the shape of the working color space 1601 and a printer's color reproduction range 1702. Referring to FIG. 17, each of primary color points 1704, 1705, 1706, 1707, 1708, and 1710 in the working color space 1701 is located on a straight line extending from a convergence point 1703 and passing through each of their corresponding primary color points in the printer's color reproduction range 1702.

Although an example in which primary color points are moved has been described in the present embodiment, points subjected to such movement are not limited to those representing primary colors. Points that represent specific colors to which greater importance is to be given, such as hues of skin, can be moved to create a working color space.

When, as described above, the shape of the working color space is to be changed by moving specific points, such as primary color points, the volume of the working color space can be reduced if, for example, the direction of compression toward the convergence point is adjusted appropriately. The reduced volume of the working color space allows an increase in mapping accuracy. The volume of the working color space can be reduced, and can even be minimized, within the range in which the color reproduction range of the printer is included.

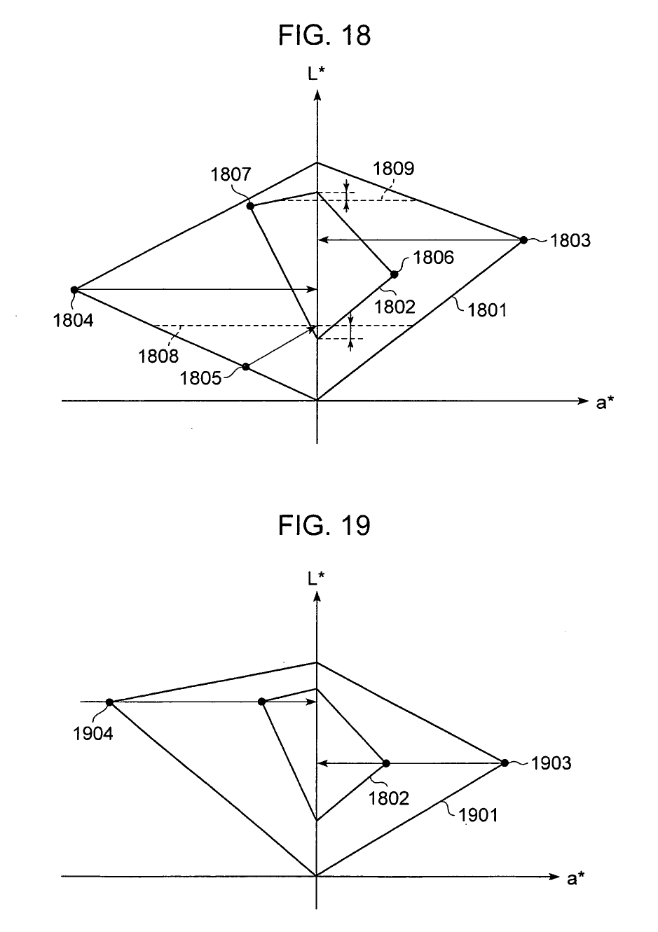

Although compression gamut mapping toward a single convergence point has been described in the present embodiment, the method of gamut mapping is not limited to this. FIG. 18 illustrates an exemplary method in which compression mapping is directed toward an achromatic axis (L* axis) while lightness (L*) is held constant.

FIG. 18 illustrates a reference working color space 1801 and a printer's color reproduction range 1802. A point 1803 and a point 1804 each represent a primary color in the working color space 1801. Compression mapping is performed on the points 1803 and 1804 in the direction of their corresponding arrows.

When lightness is to be held constant, mapping of white or near-white colors (with a high L* value) and black or near-black colors (with a low L* value) cannot be made. Therefore, in the working color space, for example, a color point 1805 (below a dashed line 1808 in FIG. 18) corresponding to black or a near-black color point in the printer's color reproduction range is mapped toward the intersection of the dashed line 1808 and the achromatic axis, while a color point (above a dashed line 1809 in FIG. 18) corresponding to white or a near-white color point in the printer's color reproduction range is mapped toward the intersection of the dashed line 1809 and the achromatic axis.

In the example illustrated in FIG. 18, in the process of compression mapping toward the achromatic axis, the primary color points 1803 and 1804 differ in terms of lightness from primary color points 1806 and 1807 in the printer's color reproduction range 1802, respectively. Therefore, the primary color points 1803 and 1804 in the working color space 1801 are moved to the respective positions of points 1903 and 1904 shown in FIG. 19. A working color space 1901 is given as a result of the above-described movement. The same operation can be performed with respect to saturation when mapping is performed while hue is held constant.

In this way, the present embodiment is applicable to compression gamut mapping where there are a plurality of compression target points.

Referring back to FIG. 13, in step S1307, information corresponding to each of primary color points R1, G′, B′, C′, M′, and Y′ (obtained by moving the R, G, B, C, M, and Y) is given to the reference transformation matrix M1 to determine a modified reference transformation matrix M0.

In this determination process, first, the primary color points R′, G′, B′, C′, M′, and Y′ are converted to points in the XYZ coordinate system in the CIE-XYZ color system. A method for converting a cyan C′ point will be described as an example. Substituting the RGB values of cyan and the reference transformation matrix M0 determined in step S1303 into Equation (1.1) gives Equation (2.1) below:

$${( \begin{matrix}X \\ Y \\ Z\end{matrix} )}_{Cyan} = ( \begin{matrix}{k}_{11} & {k}_{12} & {k}_{13} \\ {k}_{21} & {k}_{22} & {k}_{23} \\ {k}_{31} & {k}_{32} & {k}_{33}\end{matrix} ) ( \begin{matrix}0 \\ 1 \\ 1\end{matrix} ) \qquad ( 2.1 )$$

Solving Equation (2.1) gives the XYZ values of a converted cyan point. The XYZ values of other primary color points can also be determined in the same manner.

Substituting the XYZ values of a total of seven points, including the primary color points obtained in the way described above and the D50 white point being the standard light source, into Equation (1.1) gives Equation (2.2) below:

$$( \begin{matrix}k 11 & k 12 & k 13 \\ k 21 & k 22 & k 23 \\ k 31 & k 32 & k 33\end{matrix} ) ( \begin{matrix}1 & 0 & 0 & 0 & 1 & 1 & 1 \\ 0 & 1 & 0 & 1 & 0 & 1 & 1 \\ 0 & 0 & 1 & 1 & 1 & 0 & 1\end{matrix} ) = ( \begin{matrix}{X}_{R} & {X}_{G} & {X}_{B} & {X}_{C} & {X}_{M} & {X}_{Y} & {X}_{W} \\ {Y}_{R} & {Y}_{G} & {Y}_{B} & {Y}_{C} & {Y}_{M} & {X}_{Y} & {X}_{Y} \\ {Z}_{R} & {Z}_{G} & {Z}_{B} & {Z}_{C} & {Z}_{M} & {Z}_{Y} & {Z}_{Y}\end{matrix} ) \qquad ( 2.2 )$$

Solving Equation (2.2) gives the transformation matrix M1 with modified primary color points. Equation (2.2) has nine unknowns and thus cannot be solved exactly, as the number of equations is larger than that. Therefore, in the present embodiment, a pseudo inverse matrix, which is a technique of the least-square method, is used to determine the reference transformation matrix M1. The solution for the reference transformation matrix M1 is not limited only to the least-square method.

The obtained transformation matrix M1 is an approximate solution and may differ from the luminance of the standard light source (D50 in the present embodiment) defined in step S1302. Therefore, in step S1308, a known chromatic adaptation formula, such as the Bradford chromatic adaptation math, is used to ensure chromatic adaptation to D50 luminance defined in step S1302, thus converting the reference transformation matrix M1. A standard matrix M2 with adjusted primary color points is thus determined.

If the RGB working color space defined in correspondence to the XYZ color system by the standard matrix M2 determined in the way described above is expressed, for example, in the CIE-L*a*b* color system, the dimension of the color space may vary depending on the hue. Therefore, if a gamut mapping method, such as calorimetric matching, is used for mapping, the amount of underexposure varies depending on the hue. An effective way to be applied to such a case is to adjust the primary color points in the working color space W0_{Lab} such that the working color space W0_{Lab} resembles the printer's color reproduction range in shape.

By applying gamut mapping, in the direction toward compression destination points, to the RGB working color space set in correspondence to the XYZ color system by the standard matrix M2 defined in the way described above while hue is held constant, good color reproduction can be achieved without causing the reversal of color saturation and lightness associated with the gamut mapping.

### Other Embodiments

Methods for defining a working color space have been discussed in the embodiments described above. The first color space converter 601 that converts the xRGB color space 604 to the working color space defined by the above-described defining methods may be used as a profile. The processing illustrated in FIG. 7, FIG. 9, and FIG. 13 may be performed to create this profile.

In the present invention, software program code illustrated in FIG. 7, FIG. 9, and FIG. 13 for implementing the functions of the above-described embodiments may be supplied to a computer in a system or apparatus that is connected to various devices in such a manner that the various devices operate to achieve the functions of the above-described embodiments. This configuration allows the various devices to operate according to the software program code stored in the computer (CPU or micro-processing unit (MPU)) in the system or apparatus.

In this case, the software program code performs the functions of the above-described embodiments. Therefore, other embodiments of the present invention include the software program code itself and a manner for supplying the software program code to the computer, such as a storage medium storing such program code.

Examples of a storage medium storing such program code include a floppy disk, a hard disk, an optical disk, a magneto-optical disk, a compact-disk read-only memory (CD-ROM), a magnetic tape, a non-volatile memory card, and a ROM.

The functions of the above-described embodiments are performed not only in the case where a computer executes program code supplied thereto, but also in the case where the program code operates in conjunction with an OS or with other application software running on the computer. In either case, the program code is included in the embodiments of the present invention.

Moreover, the supplied program code may be stored in a memory of a function expansion board in a computer or in a memory of a function expansion unit connected to a computer. Then, a CPU or the like in the function expansion board or expansion unit executes all or part of the actual processing on the basis of instructions from the program code, thus performing the functions of the above-described embodiments. Such a case is also included in the scope of the present invention.

With the configurations described above, when a first color reproduction range is converted to a second color reproduction range in such a manner that the first color reproduction range is compressed, the first color reproduction range is defined to include all colors in the second color reproduction range. Therefore, when compression gamut mapping is performed on the first color reproduction range in a working color space, colors in the working color space can be mapped to any colors in the second color reproduction range, which is the range of colors reproducible by an output device, without dropping any colors reproducible by the output device. The full color reproduction range of the output device can thus be effectively used.

Moreover, the first color reproduction range is defined such that, when compression is applied to the first color reproduction range for conversion, a point representing a specific color in the first color reproduction range is converted to a point representing the corresponding color in the second color reproduction range. Therefore, a specific color in the working color space is converted to the corresponding specific color in the second color reproduction range of the output device. This prevents, for example, the reversal of saturation and the like which may occur when a point with the maximum saturation in the working color space is converted, in gamut mapping, to a point with a lower saturation level in the color reproduction range of the output device.

Inconvenience associated with color reproduction and caused by problems related to the shape of a working color space involved in gamut mapping can thus be prevented, and good color reproduction can be achieved.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims the benefit of Japanese Application No. 2005-120018 filed Apr. 18, 2005, which is hereby incorporated by reference herein in its entirety.

What is claimed is:

1. An image processing method comprising:
performing gamut mapping on image data in a first color reproduction range to convert the image data into image data in a second color reproduction range,
wherein the first color reproduction range is defined in a predetermined chromaticity diagram by a combination including three primary color points to include the second color reproduction range.

2. The image processing method according to claim 1, wherein the first color reproduction range includes a reference white point as well as the three primary color points, and the chromaticity diagram is expressed in the CIE-XYZ color system.

3. The image processing method according to claim 1, wherein the three primary color points are defined so as to minimize the volume of the first color reproduction range while allowing the second color reproduction range to be included in the first color reproduction range.

4. The image processing method according to claim 1, wherein the gamut mapping is a process that moves image data included in the first color reproduction range on a line segment between at least one point in the first color reproduction range and a point in the second color reproduction range corresponding to the one point in the first color reproduction range.

5. An image processing method comprising:
performing gamut mapping on image data in a first color reproduction range to convert the image data into image data in a second color reproduction range,
wherein the shape of the first color reproduction range is determined based on the shape of the second color reproduction range.

6. The image processing method according to claim 5, wherein the first color reproduction range is determined by moving at least one point in the first color reproduction range according to the shape of the second color reproduction range.

7. The image processing method according to claim 6, wherein when the number of points moved in the first color reproduction range is at least three, and the first color reproduction range is determined by calculating the first color reproduction range using a least-square method.

8. The image processing method according to claim 5, wherein the gamut mapping is a process that converts image data included in the first color reproduction range into image data included in the second color reproduction range and located on a line segment between the image data in the first color reproduction range and a predetermined point in a color space.

9. The image processing method according to claim 5, wherein the first color reproduction range is defined, in a predetermined chromaticity diagram, by a reference white point and a combination of three primary color points that allow the second color reproduction range to be included in the first color reproduction range, and
the reference white point and the three primary color points are defined by values in the CIE-XYZ color system.

10. The image processing method according to claim 9, wherein the three primary color points are defined so as to minimize the volume of the first color reproduction range while allowing the second color reproduction range to be included in the first color reproduction range.

11. A computer-readable storage medium having stored thereon a program including computer-executable instructions for performing a method comprising:
performing gamut mapping on image data in a first color reproduction range to convert the image data into image data in a second color reproduction range,
wherein the first color reproduction range is defined in a predetermined chromaticity diagram by a combination including three primary color points to include the second color reproduction range.

12. A computer-readable storage medium having stored thereon a program including computer-executable instructions for performing a method comprising:
performing gamut mapping on image data in a first color reproduction range to convert the image data into image data in a second color reproduction range,
wherein the shape of the first color reproduction range is determined based on the shape of the second color reproduction range.

13. An image processing apparatus comprising:
a conversion unit configured to perform gamut mapping on image data in a first color reproduction range to convert the image data into image data in a second color reproduction range,
wherein the first color reproduction range is defined in a predetermined chromaticity diagram by a combination including three primary color points to include the second color reproduction range.

14. An image processing apparatus comprising:
a conversion unit configured to perform gamut mapping on image data in a first color reproduction range to convert the image data into image data in a second color reproduction range,
wherein the shape of the first color reproduction range is determined based on the shape of the second color reproduction range.

15. An image processing method comprising:
converting input color data into converted color data in a first color reproduction range; and
performing gamut mapping on the converted image data in the first color reproduction range to convert the converted image data into image data in a color reproduction range of a printer,
wherein the shape of the first color reproduction range is determined based on the shape of the second color reproduction range.

16. An image processing apparatus comprising:
a first conversion unit configured to convert input color data into converted color data in a first color reproduction range; and
a second conversion unit configured to perform gamut mapping on the converted image data in the first color reproduction range to convert the converted image data into image data in a color reproduction range of a printer,
wherein the shape of the first color reproduction range is determined based on the shape of the second color reproduction range.
